(19) United States
(12) Patent Application Publication
(10) Pub. No.: US 2011/0272912 A1
(43) Pub. Date: Nov. 10, 2011

(54) MOTOR VEHICLE REAR TRAIN HAVING A TWO ARM SUSPENSION WITH A VERTICAL OPENING

(75) Inventor: François Le Gourvellec, Rambouillet (FR)

(73) Assignee: PEUGEOT CITROEN AUTOMOBILES SA, Velizy Villacoublay (FR)

(21) Appl. No.: 12/776,123

(22) Filed: May 7, 2010

(51) Int. Cl. B60G 3/18

(52) U.S. Cl. 280/124.135

(57) ABSTRACT

The goal of the invention is a rear axle (31) for automotive vehicle, including two suspension arms (22) oscillating in a vertical plane around a forward located axis, and each comprising in the rear of their respective arm, a hub support (24) for mounting of a rear wheel (34), said axle furthermore comprising a deformable cross beam (8) connecting the two suspension arms (22), characterized in that each suspension arm comprises a vertical opening with closed contour, situated in the width of the arm, arranged in front of the axis of the hub support, between the cross beam and the hub support, and accommodating a shock absorber (10) of which one lower mounting is connected to the suspension arm (22).

### CROSS-REFERENCE TO RELATED APPLICATIONS

Not Applicable.

### BACKGROUND

The present invention relates to a rear axle for automotive vehicles, and a vehicle equipped with this axle.

In general, automotive vehicles have a rear axle connected to the vehicle body, which supports the rear wheel hubs and guides the wheels in order to allow the displacement of the suspension.

A known type of rear axle, called deformable crossbeam axle, comprises two longitudinal suspension arms arranged along the sides of the vehicle. The front of these arms is connected to the body of the vehicle by an elastic connection that can pivot around a transversal axis. A wheel hub is mounted on the end of each arm.

The elastic connections filter the vibrations coming from the wheels when driving, in order to prevent the transmission of vibrations to the body of the vehicle and to limit the noise.

The rear axle is in general “H” shaped and has a transversally mounted deformable crossbeam, which is attached at its extremities to a central part of each suspension arm. This deformable crossbeam maintains the geometry of the suspension arms, while performing the function of stabilizer bar limiting the roll angle of the body through torsional deformation.

The deformable crossbeam rear axle is in general manufactured by fabrication of stamped and welded elements. This type of deformable crossbeam rear axle offers a good compromise between satisfactory guiding of the rear wheels and moderate cost. It is widely used.

The body is supported by two suspension coil springs, each resting on the rear part of a suspension arm. A hydraulic shock absorber is mounted on each suspension arm, parallel to the springs to absorb the oscillations of the body and to ensure comfort as well as road holding capability. The suspension springs and the shock absorbers transmit relatively high forces to the suspension arms. Therefore these arms must be dimensioned so as to limit their deformation.

To distribute the stresses in the suspension arms and to avoid torsional deformation, it is known in particular through French Patent FR2636571 (also published as GB2223990), to provide a support for the suspension spring in the axis of these arms. A cavity is created in the upper part of the suspension arm, approximately according to its axis and approximately in the middle of the height of this arm, to form a seat that accommodates the base of the suspension spring.

It is however difficult to provide a lower mounting of a shock absorber that is centered on the axis of the suspension arm, while limiting the stresses in the arm due to the reaction forces of the shock absorber.

### BRIEF SUMMARY

The specific goal of the present invention is to avoid these inconveniences of the prior technology, and to propose a rear axle that allows simple and inexpensive mounting of the shock absorbers and limits the stresses applied to the suspension arms.

To this end, a rear axle for automotive vehicle is provide which includes two suspension arms oscillating in an approximately vertical plane around a forward located axis; and each arm comprising in the rear of its respective arm, a hub support for mounting of a rear wheel. The axle furthermore comprises a deformable crossbeam connecting the two suspension arms. Each suspension arm comprises an approximately vertical opening with closed contour, situated in the width of the arm, arranged in front of the hub support axis, between the crossbeam and the hub support, and accommodating a shock absorber of which one lower mounting is connected to the suspension arm.

Advantageously, the opening is traversed from side to side by the shock absorber. Indeed, one advantage of the rear axle is that the shock absorber traversing the suspension arm along the width of this arm, makes it possible to mount the base of this shock absorber in a centered manner under the suspension arm, and in this way to balance the reaction forces.

In addition, the rear axle according to the invention can include one or more of the following characteristics, which can be combined among them.

Advantageously, the suspension arm includes an upper plate and a lower plate, each comprising a hole. The holes in the plates are aligned with each other and form the opening, while a reinforcement tube traversing this opening is attached to these two plates.

The base of the reinforcement tube can include a cutout comprising two transversally aligned holes, receiving a clamping shaft, to form a shell surrounding a lower attachment of the shock absorber and connecting it to the suspension arm.

According to one aspect, each suspension arm includes a longitudinal body made of stamped plate formed in general in the shape of a “U”, comprising two wings arranged approximately flat, corresponding respectively with upper and lower plate.

The reinforcement tube can be welded to the edge of the holes in the two wings of the “U” section.

The reinforcement tube can be made from a thin plate which is rolled inside the holes.

The opening made in the suspension arm can have a longitudinally elongated form, and the lower mounting of the shock absorber is approximately centered in the length of this opening.

A deformable crossbeam can be attached by its extremities, to a central part of the suspension arms.

According to a variant, each suspension arm includes a front half-arm and a rear half-arm, directly mounted on the deformable crossbeam.

According to another variant, the deformable crossbeam includes backward bent extremities forming integrated rear suspension half-arms, while two forward facing front suspension half-arms are attached to this crossbeam.

The goal of the invention is also an automotive vehicle comprising a rear axle as described above.

### BRIEF DESCRIPTION OF THE SEVERAL VIEWS OF THE DRAWINGS

The invention will be better understood and other characteristics and advantages will become clear by reading the following description, given as an example with reference to the attached drawings in which:

FIG. 1 is an isometric view of a rear half-axle according to prior technology;

FIG. 2 is an isometric view of rear half-axle according to the invention, according to a first version;

FIG. 3 is a detail view of the suspension arm of this rear half-axle;

FIG. 4 is an isometric view of a rear half-axle according to the invention, according to a second version, and

FIG. 5 is an isometric view of a rear half-axle according to the invention, according to a third version.

### DETAILED DESCRIPTION

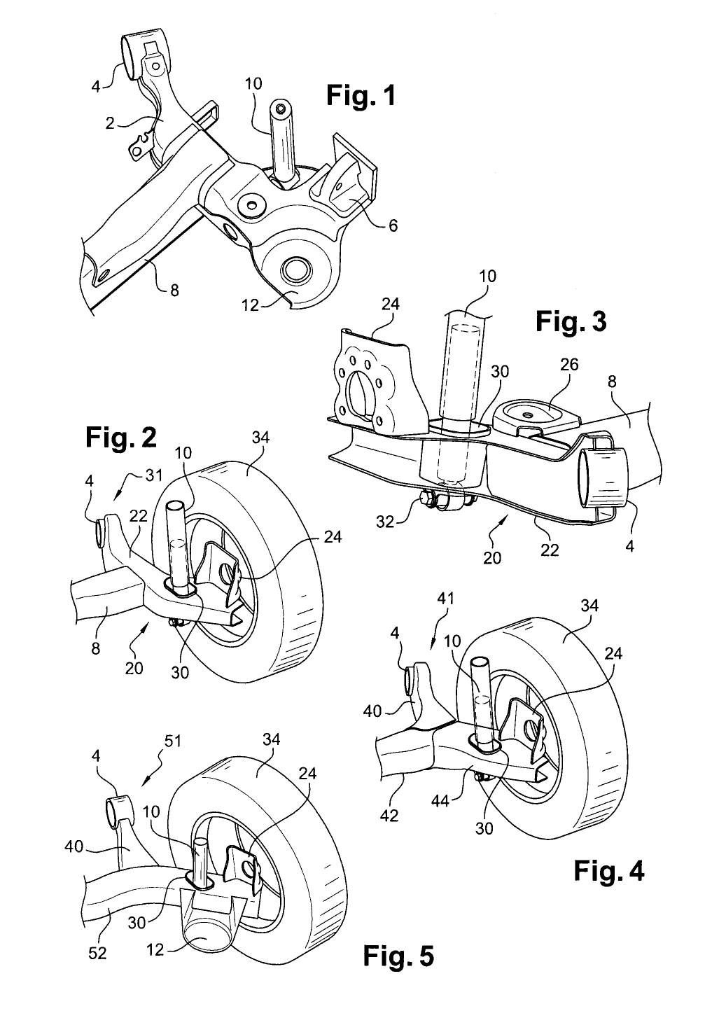

FIG. 1 (prior art) shows the right lateral side of a rear half axle including a suspension arm 2 arranged longitudinally along the side of the vehicle. The front of this suspension arm 2 comprises a sleeve 4 with an approximately transversal axis. This sleeve accommodates an elastic block inserted in a yoke attached to the vehicle body, forming an elastic articulation that filters the vibrations.

The rear of the suspension arm 2 comprises a hub support 6, which supports in bearings a transversal axis on which the wheel is mounted.

The extremities of a deformable beam 8 are attached to the suspension arm 2, in a central point of this arm. This deformable beam 8 maintains the geometry of the suspension arm 2, and constitutes a torsion spring that limits the travel difference of these arms.

The suspension arms 2 comprise in the rear, an approximately horizontal support 12 formed by a stamped plate, accommodating the lower extremity of a suspension coil spring.

A hydraulic shock absorber 10, comprising a sliding screw-jack of which the upper extremity is attached to the vehicle body, passes along the exterior side of the suspension arm 2, just before the hub support 6.

The lower extremity of this hydraulic shock absorber 10 has a sleeve with an internal rubber ring. A transverse shaft passing through this ring is attached to the suspension arm 2, ensuring an elastic connection. This transverse shaft can comprise a mounting bolt that is screwed in a hole of a cylindrical strut, welded on the side of suspension arm 2.

The body of hydraulic shock absorber 10 has a specific diameter, and is sufficiently remote from the suspension arm 2 along which it runs, to avoid contact during the travel of the suspension. The transverse shaft attached to the base of shock absorber 10, can be mounted in a yoke, which complicates the fabrication of the rear axle.

The transverse shaft can also be mounted in overhang. This shaft works then in flexion, and must have a large diameter to carry the loads.

In a variant, the shock absorber 10 can be mounted on the interior side of the suspension arm 2, close to the deformable beam 8. In this case, it is difficult to align and to weld inside suspension arm 2, a cylindrical strut accommodating the mounting shaft of the shock absorber 10.

For these different solutions, the lower mounting of shock absorber 10 is offset relative to the axis of the suspension arm 2, so that the twisting of this arm makes this shock absorber work with the alignment defects of its mountings. These defects cause fatigue of the rubber rings in the mountings, and provoke internal friction and higher wear of the shock absorber.

In all cases, the thicker plates or the reinforcements necessary on suspension arm 2 to withstand the flexion forces, lead to higher weight of the rear axle.

FIGS. 2 and 3 show for a rear axle 31 according to the invention, a suspension arm 20 comprising a longitudinal body 22 connecting sleeve 4 with hub support 24, on which is welded the cross beam 8.

The longitudinal body 22 comprises a stamped plate with “U” section which extends along this body. The “U” section of this body 22 comprises two flat wings, while the open side of this section is directed towards the exterior of the vehicle. Made from a single piece of plate, the body 22 of the suspension arm 2 is inexpensive.

The deformable cross beam 8 is welded towards the interior, on the closed side of the section. The hub support 24 includes a stamped plate welded to body 22 and carries a wheel 34 and seat 26 which accommodates the base of the suspension coil spring.

The wings of the “U” section of body 22, each comprise holes that are aligned with each other forming an approximately vertical opening which traverses the suspension arm 20. These holes are in front of the axis of hub support 24 and between the deformable cross beam 8 and the axis of hub support 24.

This opening accommodates a reinforcement tube 30 traversing from side to side body 22 of suspension arm 20, and protruding on each side; this tube is mounted in an aligned manner in the two holes in the wings of this body. Welds made on the edges of the holes in the two wings of body 22, connect these wings with the reinforcement tube 30.

In this way a rigid assembly is created of tube 30 welded to the two wings of body 22 and connecting these two wings, and providing a significant reinforcement for the suspension arm 20.

The base of the reinforcement tube 30 comprises a cutout comprising two lower bosses, each containing a hole receiving a mounting bolt 32 aligned according to a transverse axis of the vehicle, which passes through this tube. The bosses form a yoke accommodating in its inside the base of shock absorber 10, while the mounting bolt 32 traverses the lower sleeve of this shock absorber which is supported from the two sides by reinforcement tube 30.

Advantageously, reinforcement tube 30 is made by rolling thin plate, which is an inexpensive method.

In this way, a yoke assembly is formed that balances the loads, while the mounting bolt 32 is not subjected to bending stresses. Therefore, mounting bolt 32 can be of reduced diameter and length relative to the overhang assembly.

In addition, the forces transmitted by shock absorber 10 passing through the axis of the suspension arm 20, apply few torsional stresses on this arm. Body 22 is easier to make from stamped plate with reduced thickness, this allows for lighter fabrication with higher precision.

The opening made in the wings of body 22 of the suspension arm 20, has a longitudinally elongated form. Mounting bolt 32 is centered in the middle of this elongated form in order to accommodate in longitudinal direction, the base of shock absorber 10 approximately in the center of this opening when the suspension is at rest.

During the movements of the suspension arm 20 due to the travel of the suspensions, shock absorber 10 can oscillate in the elongated opening relative to this arm, towards the front or the rear.

In addition, the longitudinal diameter of the reinforcement tube 30 can be reduced towards the bottom and enlarged towards the top, so that the section of the reinforcement tube 30 is reduced to the minimum necessary to ensure the movements of the shock absorber 10.

FIG. 4 shows a variant rear axle 41, including a deformable cross beam 42 comprising, welded at its extremity, a forward facing front suspension half arm 40, which is connected with a backward facing rear suspension half arm 44. Connected together, these two half arms 40, 44 form a complete arm having the same functionalities as the previously presented suspension arm, including the elastic articulation in front and the hub support 24 in the back.

The longitudinal body of the rear half arm 44 can be made similarly from plate stamped in “U” shape with the opening facing towards the exterior of the vehicle.

The wings of the “U” section of the rear half arm 44, each comprise a hole forming a vertical opening which receives the reinforcement tube 30 traversing the suspension arm 20. In this way, the same advantages are obtained as presented above for the mounting of shock absorber 10 and the reinforcement of the rear suspension half arm 44.

FIG. 5 shows, as a second variant, a rear axle 51 comprising a deformable cross beam 52 of which the extremities are curved toward the back, forming two integrated rear suspension half arms. A forward facing front suspension half arm 40 is welded at the location of the curvature of this deformable cross beam 52.

In this way, the number of parts constituting rear axle 51 is reduced, making it easier to manage its production.

The deformable cross beam 52 including its extremity parts forming the rear half-arms, is made of stamped plate with “U” section, the opening of which faces the front of the vehicle.

The wings of the “U” section of the rear half arms, accommodate in the same manner the reinforcement tube 30.

1. A rear axle for automotive vehicle, including two suspension arms which can oscillate in a vertical plane around a forward located axis, and each comprising in a rear of the respective arm, a hub support for mounting a rear wheel; said axle further including a deformable cross beam connecting the two suspension arms; each suspension arm comprising a vertical opening with closed contour, situated in the width of the arm, arranged in front of the axis of the hub support, between the cross beam and the hub support, and accommodating a shock absorber of which one lower mounting is connected to the suspension arm.

2. The rear axle as set forth in claim 1 wherein said opening is traversed from side to side by the shock absorber.

3. The rear axle as set forth in claim 1 wherein in that the suspension arm includes an upper plate and a lower plate each comprising a hole, the holes be aligned with each other to form the opening; and a reinforcement tube traversing this opening being attached to the two plates.

4. The rear axle as set forth in claim 3, characterized in that the base of the reinforcement tube includes a cutout comprising two transversally aligned holes accommodating a clamping shaft; said cutout constituting a yoke surrounding the lower mounting of shock absorber and connecting it to the suspension arm.

5. The rear axle as set forth in claim 3 wherein the suspension arm includes a longitudinal body made from a stamped plate with a general shape of a “U” comprising two wings placed approximately flat; said wings corresponding respectively with the upper and lower plates.

6. The rear axle as set forth in claim 5 wherein the reinforcement tube is welded to the edges of the holes in the two wings of the “U” section.

7. The rear axle as set forth in claim 3 wherein the reinforcement tube is made from thin plate which is rolled inside the holes.

8. The rear axle as set forth in claim 1 wherein the opening made in the suspension arm has a longitudinally elongated form, and the lower attachment of the shock absorber is approximately centered relative to the length of this opening.

9. The rear axle as set forth in claim 1 wherein the deformable cross beam is attached by its extremities to a central part of the suspension arms.

10. The rear axle as set forth in claim 1 wherein each suspension arm includes a front half arm and a rear half arm directly attached to the deformable cross beam.

11. The rear axle as set forth in claim 1 wherein the deformable cross beam includes two backward bent extremities forming two integrated rear suspension half arms; and wherein two forward facing front suspension half arms are attached to this cross beam.

12. An automotive vehicle including a rear axle; the rear axle including two suspension arms which can oscillate in a vertical plane around a forward located axis, and each comprising in a rear of the respective arm, a hub support for mounting a rear wheel; said axle further including a deformable cross beam connecting the two suspension arms; each suspension arm comprising a vertical opening with closed contour, situated in the width of the arm, arranged in front of the axis of the hub support, between the cross beam and the hub support, and accommodating a shock absorber of which one lower mounting is connected to the suspension arm.
